(19) United States
(12) Patent Application Publication
(10) Pub. No.: US 2006/0131979 A1
(43) Pub. Date: Jun. 22, 2006

(54) Variable reluctance motor with separated stator cores

(76) Inventors: Koen A. Gieskes, Deposit, NY (US); Darrin M. Weiss, Vestal, NY (US); Andrew Zalesski, Apalachin, NY (US)

Correspondence Address: Schmeiser, Olsen & Watts LLP;Suite 201, 3 Lear Jet Lane, Latham, NY, 12110, US

(21) Appl. No.: 11/018,165

(22) Filed: Dec. 21, 2004

(51) Int. Cl. H02K 19/20; H02K 19/24; H02K 17/42

(52) U.S. Cl. 310/168

(57) ABSTRACT

A stator for a variable reluctance motor system is disclosed and the method of assembly thereof. The stator has a plurality of stator cores separated by nonferromagnetic material from each other. The assembly of the stator cores comprises stacking a plurality of lamina into a lamination stack, and then removing a portion of the lamination stack to expose the separated stator cores.

### BACKGROUND OF THE INVENTION

1. Technical Field

This invention relates to stators for use within a two-sided variable reluctance motor system, and the method of assembly thereof.

2. Related Art

Two-sided variable reluctance motors (herein after “VRM”) systems comprise of a motor and a stator having relative motion there between. As used herein, the term motor refers to the part of the machine containing windings, and the term stator refers to the part of the machine without windings. Each motor comprises one or more phase units with windings. When current is applied to the windings, a flux path is generated within the phase unit, which then passes through to the stator, and then on through to a phase unit on the opposite side of the stator. In the case of two-sided VRM systems, flux can leak through the stator as opposed to traveling through to the opposite phase unit. This leakage results in an increase in the acoustic noise produced by the VRM system.

A need exists for a stator, and VRM system, that overcomes the aforementioned, and other deficiencies in the art.

### SUMMARY OF THE INVENTION

The present invention, inter alia, reduces the acoustic noise generated by a VRM system. The VRM system comprises a motor and a stator having relative motion there between. The motor further comprises two or more phase units and the stator comprises of plurality of ferromagnetic cores (hereinafter “stator cores”). The stator cores are constructed so that the flux path can flow only in primarily in direction between the phase units on opposite sides of the stator and the aforementioned flux flow in the direction between the stator cores is minimized. This reduces the imbalance of the attractive forces between the phase units and the stator and as a result, the acoustic noise generated by the VRM system is also reduced.

A first general aspect of the present invention is a variable reluctance motor system comprising:
a motor; and
a stator wherein, the stator further comprises a plurality of separated stator cores.

A second general aspect of the present invention is a method of making a stator for a variable reluctance motor system comprising the steps of:
providing a plurality of lamina;
stacking said plurality of lamina, thereby defining at least two sides;
attaching said lamination stack together; and

removing a portion of said at least two sides of said lamination stack

A third general aspect of the present invention is a stator for use with a variable reluctance motor system comprising:
a plurality of separated cores.

### BRIEF DESCRIPTION OF THE DRAWINGS

A complete understanding of the present invention may be obtained by reference to the accompanying drawings, when considered in conjunction with the subsequent detailed description, in which:

FIG. 1A depicts a variable reluctance motor system, in accordance with the present invention;

FIG. 1B depicts a portion of a stator, in accordance with the present invention;

FIG. 2 depicts a top, sectional view of a portion of a VRM system in the linear configuration and the flux path generated therethrough, of the related art;

FIG. 3 depicts top, sectional view of a portion of a VRM system in the rotary configuration and the flux path generated therethrough, of the related art;

FIG. 4 depicts a top, sectional view of a portion of a VRM system in the linear configuration and the flux path generated therethrough, in accordance with the present invention;

FIG. 5 depicts top, sectional view of a portion of a VRM system in the rotary configuration and the flux path generated therethrough, in accordance with the present invention;

FIG. 6A depicts a top perspective view of a portion of a single lamina, in accordance with the present invention;

FIG. 6B depicts a top perspective view of a portion of a lamination stack, in accordance with the present invention;

FIG. 6C depicts a top perspective view of a portion of a lamination stack bonded together with nonferromagnetic material, in accordance with the present invention;

FIG. 7A depicts a top perspective view of the adding of stator rails to the portion of a lamination stack, in accordance with the present invention; and

FIG. 7B depicts a top perspective view of a portion of the stator before removal of parts of the lamination, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. and are disclosed simply as an example of an embodiment. The features and advantages of the present invention are illustrated in detail in the accompanying drawings, wherein like reference numerals refer to like elements throughout the drawings.

The present invention pertains to a stator for use within a variable reluctance motor (herein after “VRM”) system and the method of assembly thereof. The VRM system comprises a motor and a stator having relative motion there between. The motor further comprises two or more phase units and the stator comprises of plurality of ferromagnetic cores (herein after “stator cores”). The stator cores are separated, fully or partially, by nonferromagnetic material(s), thereby creating a VRM system that has as a flux path, a path that can flow only primarily in the direction between the phase units located on opposite sides of the stator and any flux flow in the direction between the stator cores is thereby minimized. This reduces the imbalance of the attractive forces between the phase units and the stator and as a result, the acoustic noise generated by the VRM system is also reduced.

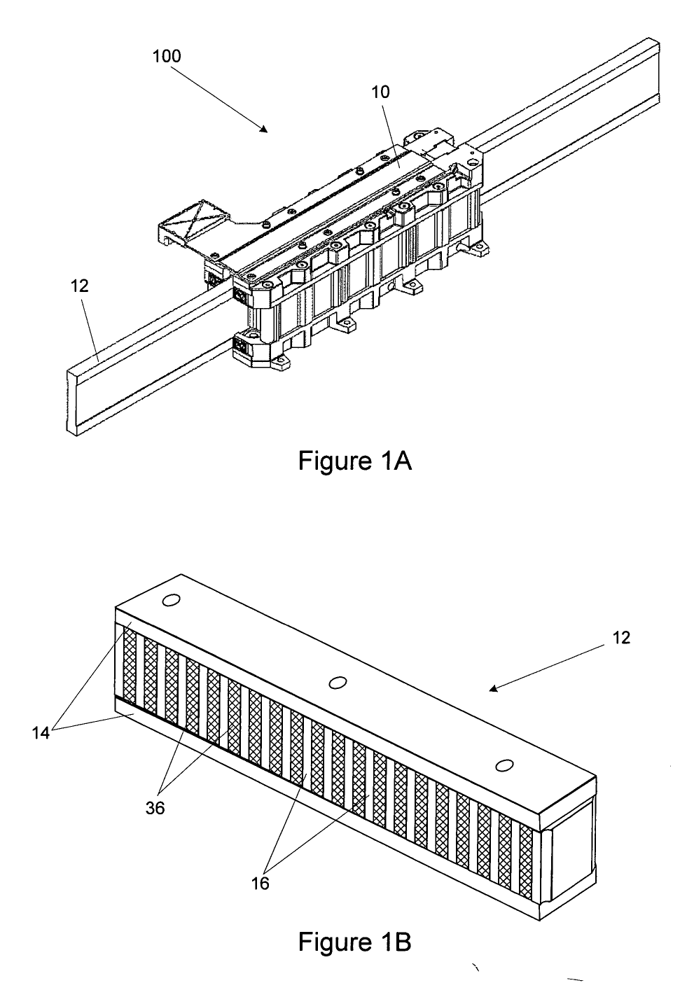

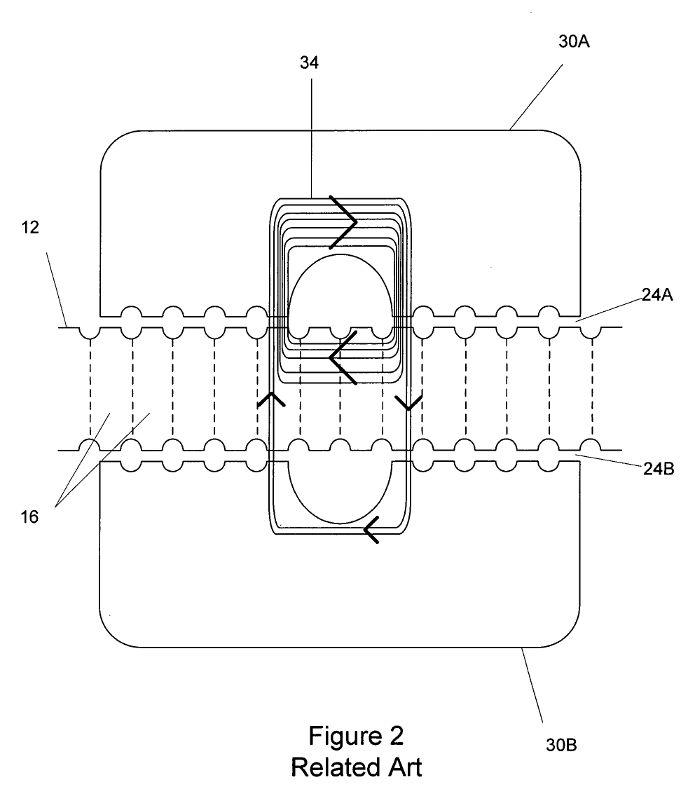

Turning first to FIG. 1A which depicts a VRM system 100 comprising a motor 10 and stator 12. The VRM system 100 may be used in many different environments and applications. For example, the VRM system 100 may be used in a component pick and place machine or as a system for providing motive power to a vehicle. The motor 10 further comprises one or more phase units. Each phase unit comprises a motor core 30A (see FIGS. 2-5) with windings (not shown). FIG. 1B shows a portion of stator 12. Stator 12 further comprises stator cores 16 separated by a nonferromagnetic material 36 and stator rails 14. Application of current to the windings of the phase unit generates a flux path 34 between the stator cores 16 and the motor cores 30A, 30B on each side of the stator 12. This in turn causes motor 10 and stator 12 to move relative to each other.

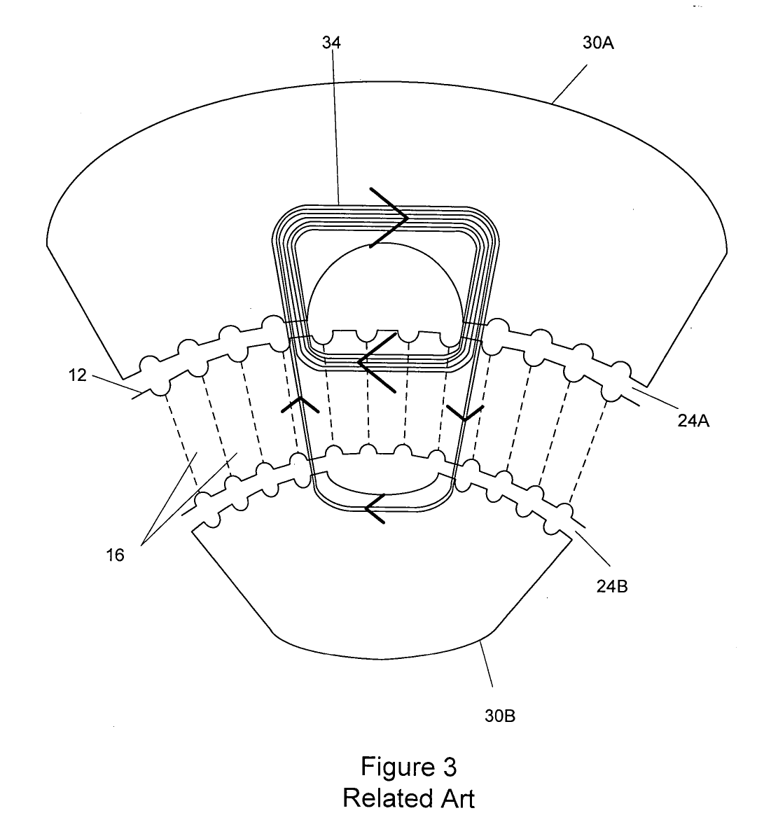

Turning now to FIGS. 2 and 3, which depict top sectional views of a portion of a VMR system and the flux path 34 between motor cores 30A, 30B and stator cores 16 in both a linear and a rotary configured VRM system in the related art. If the gaps 24A, 24B are imbalanced and the stator cores 16 are not separated (e.g., entirely made of ferromagnetic material), a greater amount flux flow of flux path 34 is allowed to pass from one motor core 30A through stator cores 16 and back to the same motor core 30A without passing through the opposite motor core 30B on the opposite side of stator 12. This causes an imbalance of the attractive forces between the phase unit and the stator 12 resulting in an increase in acoustic noise.

The present invention is not limited to the particular shape of motor core 30A, 30B shown. One of ordinary skill in the art would contemplate that other shapes (e.g. “E-core”, “M-core”, etc.) of motor core 30A, 30B could be used according to the present invention.

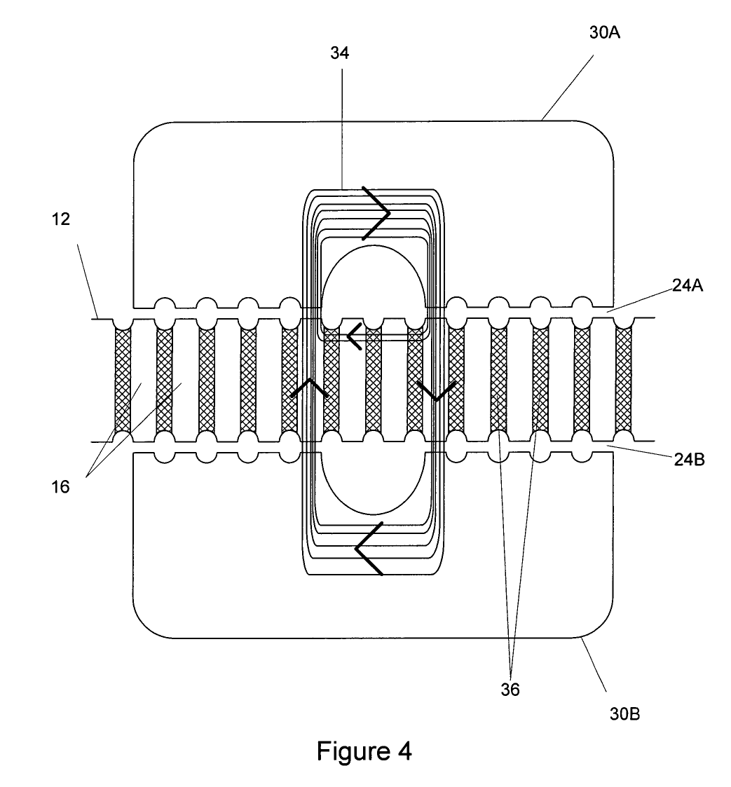

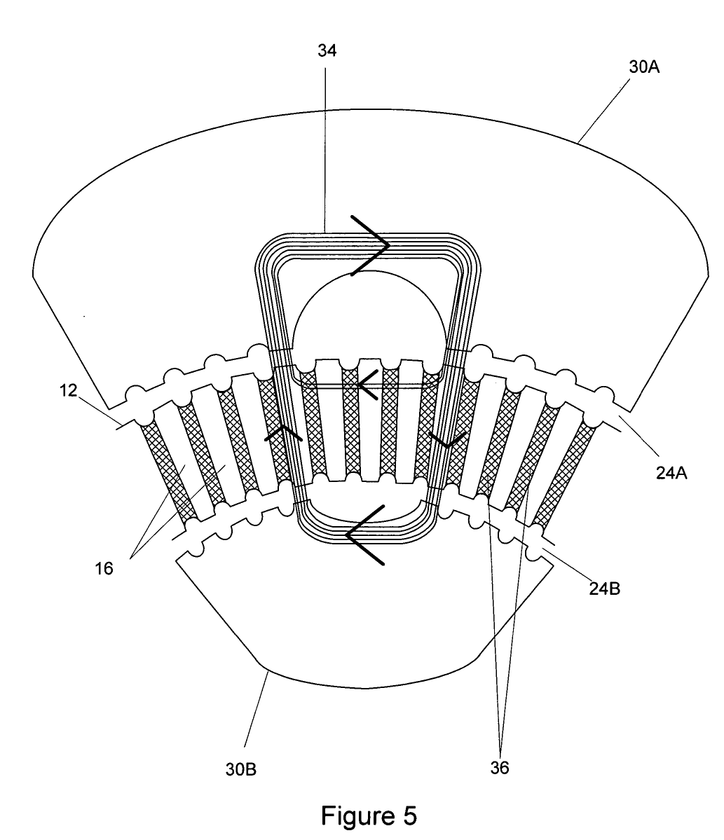

Referring now to FIGS. 4 and 5, which depicts an embodiment of the present invention for a stator 12 with separated stator cores 16 in both the linear and rotary configuration, respectively, of a VRM system. Stator cores 16 are separated, partially or fully, by a nonferromagnetic material 36 which forces the majority of the flow of flux path 34 to flow from one motor core 30A, through the stator core(s) 16, then on to the other motor core 30B on the opposite side of stator 12, and then returning, thereby minimizing the flow of any flux throughout portions of the stator 12. Because the flux path 24 is more uniform across the stator 12 and between motor cores 30A, 30B, any tendency for either motor core 30A, 30B to move towards the stator 12 is minimized. That is, as a result of the invention, gaps 24A, 24B between the motor cores 30A, 30B, and stator 12 are more apt to be kept uniform, thereby reducing the imbalance of the attractive forces between the phase unit and stator 12 and the resulting acoustic noise.

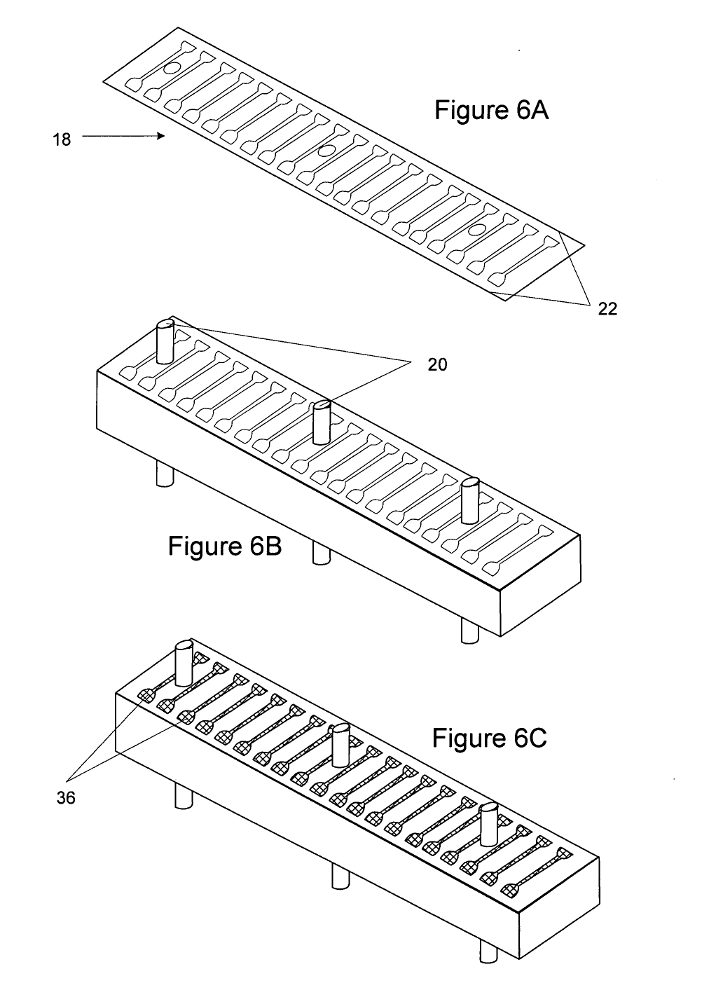

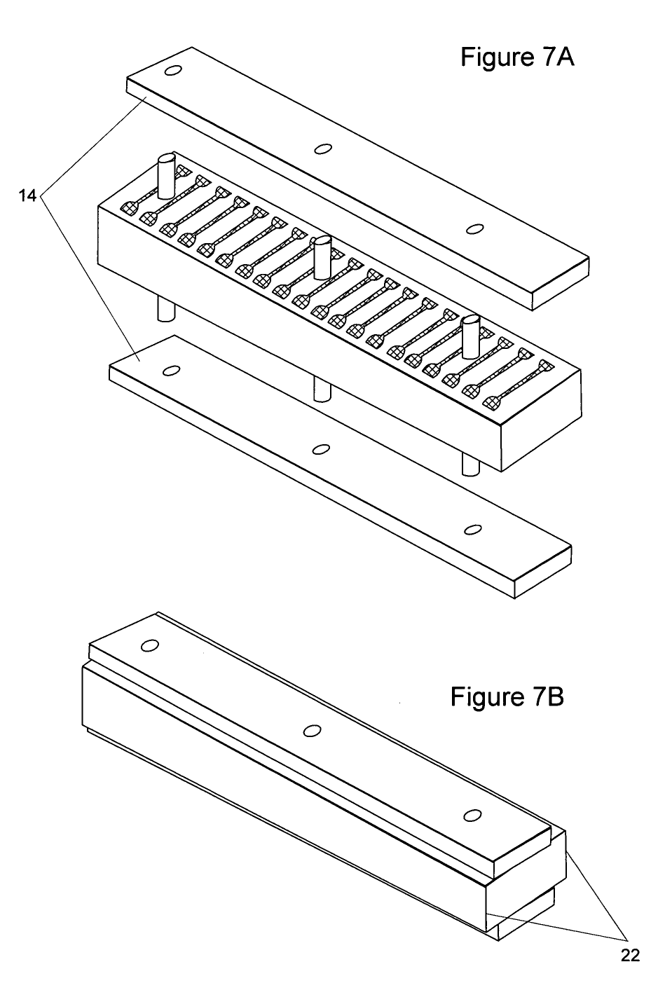

Another aspect of the present invention is the assembly of a stator 12 as shown in one embodiment in FIGS. 6 through 7. Stator 12 comprises stator rails 14 and stator cores 16. The assembly of stator 12 begins with a plurality of lamina 18. Laminations 18 are formed such that when portions of the sides 22 are removed later in the assembly process, stator cores 16 will be created that are separated from each other. The assembly process begins with stacking a plurality of lamina 18 on pins 20 (FIG. 6B), wherein the lamina 18 are of a ferromagnetic material. When the stacked thickness meets the requirements for the desired VRM system, a nonferromagnetic material 36 is added to attach or bond the stack together (FIG. 6C) and stator rails 14 are added to both top and bottom (FIGS. 7A and 7B). Portions of the sides 22 are then removed to expose the stator cores 16 (FIG. 1B).

Since other modification and changes varied to fit particular operating requirements and environments will be apparent to those skilled in the art, the invention is not considered limited to the example chosen for purposes of disclosure, and covers all changes and modification which do not constitute departures from the true spirit and scope of this invention.

1. A variable reluctance motor system comprising:
a motor; and
a stator wherein, the stator further comprises a plurality of separated stator cores.

2. The system of claim 1, further wherein the stator cores are separated by a nonferromagnetic material.

3. The system of claim 1, further wherein the stator cores are partially separated by a nonferromagnetic material.

4. A method of making a stator for a variable reluctance motor system comprising the steps of:
providing a plurality of lamina;
stacking said plurality of lamina, thereby defining at least two sides;
attaching said lamination stack together;
removing a portion of said at least two sides of said lamination stack;
creating a plurality of separated stator cores.

5. The method of claim 4, wherein said attaching further comprises using a nonferromagnetic material.

6. A stator for use with a variable reluctance motor system comprising:
a plurality of separated cores.

7. The stator of claim 6, wherein said plurality of cores are comprised of a ferromagnetic material.

8. The stator of claim 6, wherein said plurality of separated cores are partially separated by a nonferromagnetic material.

9. The stator of claim 6, wherein said plurality of separated cores are separated by a nonferromagnetic material.
